(19) United States
(12) Patent Application Publication
(10) Pub. No.: US 2008/0215358 A1
(43) Pub. Date: Sep. 4, 2008

(54) METHOD, SYSTEM, AND STORAGE MEDIUM FOR IMPLEMENTING BUSINESS PROCESS MODULES

(75) Inventors: German S. Goldszmidt, Westchester, NY (US); Joshy Joseph, Poughkeepsie, NY (US); James G. Massie, Hinsdale, IL (US); Lance Walker, Longmont, CO (US)

Correspondence Address: CANTOR COLBURN LLP-IBM YORKTOWN, 20 Church Street, 22nd Floor, Hartford, CT, 06103, US

(73) Assignee: International Business Machines Corporation, Armonk, NY (US)

(21) Appl. No.: 12/119,798

(22) Filed: May 13, 2008

Related U.S. Application Data
(63) Continuation of application No. 10/995,670, filed on Nov. 23, 2004.

(51) Int. Cl. G06Q 30/00

(52) U.S. Cl. 705/1

(57) ABSTRACT

Exemplary embodiments include a method for implementing business process modules for performing business process modeling. The method includes identifying tasks required in order to achieve a capability and designing a process module for enabling the capability. The designing includes interconnecting logic flow among the tasks resulting in an optimized, repeatable pattern of logically transformed inputs to outputs required for achieving the capability. The method also includes selecting and associating attributes to the tasks. The attributes are selected from categories including: information technology component services, data, operational business rules, roles, and measurements. The method further includes defining and associating metadata with the process module. The metadata describes functional capabilities provided by the process module and business and technical contexts into which the process module is used.

### CROSS-REFERENCE

This application is a continuation of U.S. patent application Ser. No. 10/995,670, filed Nov. 23, 2004, the disclosure of which is incorporated by reference herein in its entirety.

### BACKGROUND OF THE INVENTION

The invention relates generally to business process modeling and, more particularly, to a method, system, and storage medium for implementing business process modules using reusable business process modeling artifacts and information technology components.

Organizations develop business models to create, organize, and implement business plans for solving business problems or exploiting business opportunities. Due to various factors, however, either anticipated or unforeseen, it is often difficult to satisfactorily develop and implement a business plan using these models. For example, very often an enterprise will need to re-strategize as a result of changes in marketplace conditions, customer demand, governmental regulations, economic factors, and technology requirements, to name a few. Oftentimes, enterprises find that they are unable to change their business processes and enabling information technology (IT) applications/infrastructure fast enough to keep pace with these changing conditions, nor are they able to dynamically adapt their processes or applications for on demand responsiveness.

Moreover, businesses traditionally create processes and IT applications as contiguous design flows without reusable constructs. Also, businesses generally associate IT applications to processes after completion of the business process design, thus requiring a more intensive IT association phase after the completion of a process modeling phase.

It is desirable, therefore, to provide a method for creating a single reusable business process modeling construct (i.e., “process module”), which defines and packages business process segments and includes IT references for reuse.

### BRIEF SUMMARY OF THE INVENTION

Exemplary embodiments include a method to define a process model artifact, that can be reused, in business process modeling activities. The method includes identifying the tasks required in order to achieve a capability and designing a process module for enabling the capability. The design activities include interconnecting logic flow among the tasks resulting in an optimized, repeatable pattern of logically transformed inputs to outputs required for achieving the capability. The method also includes selecting and associating attributes to the tasks. The attributes are selected from categories including: information technology component services, data, operational business rules, roles, and measurements. The method further includes defining and associating metadata with the process module. The metadata describes functional capabilities provided by the process module and business and technical contexts into which the process module is used.

Exemplary embodiments also include a system for implementing business process modeling activities. The system includes a user system including a processor. The user system is in communication with a storage device. The system also includes a process module configurator application executing on the user system. The process module configurator application performs a method. The method includes identifying tasks required in order to achieve a capability and designing a process module for enabling the capability. The designing includes interconnecting logic flow among the tasks resulting in an optimized, repeatable pattern of logically transformed inputs to outputs required for achieving the capability. The method also includes selecting and associating attributes to the tasks. The attributes are selected from categories including: information technology component services, data, operational business rules, roles, and measurements. The method further includes defining and associating metadata with the process module. The metadata describes functional capabilities provided by the process module and business and technical contexts into which the process module is used.

Exemplary embodiments further include a storage medium for implementing business process modeling activities. The storage medium includes machine-readable program code including instructions for causing a processor to implement a method. The method includes identifying tasks required in order to achieve a capability and designing a process module for enabling the capability. The designing includes interconnecting logic flow among the tasks resulting in an optimized, repeatable pattern of logically transformed inputs to outputs required for achieving the capability. The method also includes selecting and associating attributes to the tasks. The attributes are selected from categories including: information technology component services, data, operational business rules, roles, and measurements. The method further includes defining and associating metadata with the process module. The metadata describes functional capabilities provided by the process module and business and technical contexts into which the process module is used.

Other methods, systems, and computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system for implementing the process module configurator in exemplary embodiments;

FIG. 2 is a graphical representation of a process module and its attributes in exemplary embodiments;

FIG. 3 is a flow diagram of a process for implementing the process module configurator in exemplary embodiments of the invention; and

FIG. 4 is a user interface screen illustrating a sample main menu for accessing the features provided by the process module configurator in exemplary embodiments.

FIGS. 5A and 5B are flowcharts illustrating how the process software implementing the systems and methods of the invention may be integrated into client, server, and network environments;

FIGS. 6A and 6B are flowcharts illustrating various ways in which the process software of the invention may be semi-automatically or automatically deployed across various networks and onto server, client (user), and proxy computers;

FIGS. 7A through 7C are flowcharts illustrating how process software for implementing the systems and methods of the invention are deployed through the installation and use of two different forms of a virtual private network (VPN); and

FIGS. 8A and 8B are flowcharts illustrating how the process software for implementing the systems and methods of the invention can be deployed through an On Demand business model, which allows the process software to be shared and simultaneously service multiple customers in a flexible, automated fashion under a pay-for-what-you-use plan.

### DETAILED DESCRIPTION

The process module configurator provides a method for creating a single reusable business process construct (i.e., “process module”), which defines and packages business process segments and includes information technology (IT) references for reuse. The process module configurator enables an individual to define a method consisting of a sequence of specific steps, using multiple artifacts (process tasks, with configurable IT application component services, data, measurement definitions, business rules, and roles) to define, design and package a new process model artifact, or module. A process module implements one or more business capabilities, each of which describes a specific function that is required in order to achieve these capabilities. These process modules may be easily used in multiple instances for assembling process models of business solutions. These process modules may also be repurposed, as they are easily adaptable to support changing business requirements.

The process module configurator enables businesses to encapsulate business functions as assets by codifying ‘best practice’ process designs into rapidly reusable and selectively adaptable process modules. The use of process modules can reduce business solution time-to-value, and related costs/expenses, especially in the design, development, testing, and deployment phases of solution projects. In addition, process modules that are instantiated as workflow segments enable those workflow segments to be more quickly and easily adapted to changing, on demand market requirements than the more traditional monolithic solution designs. Process modules have associated metadata (e.g., process module business purpose, functional capabilities, key search words, cost metrics, etc.), to assist users in efficiently and effectively governing, searching, selecting, and using process modules.

Additionally, the process module configurator enables an enterprise to drastically reduce the amount of human labor required in the second phase of IT enablement of business plans, as IT references are encapsulated directly within the process modules. The process module configurator reduces the total solution creation time, with an approach based upon pre-built and tested, reusable process modules with integral IT function references. Process modules help to reduce development costs and allow solutions to be delivered into the marketplace at a faster pace.

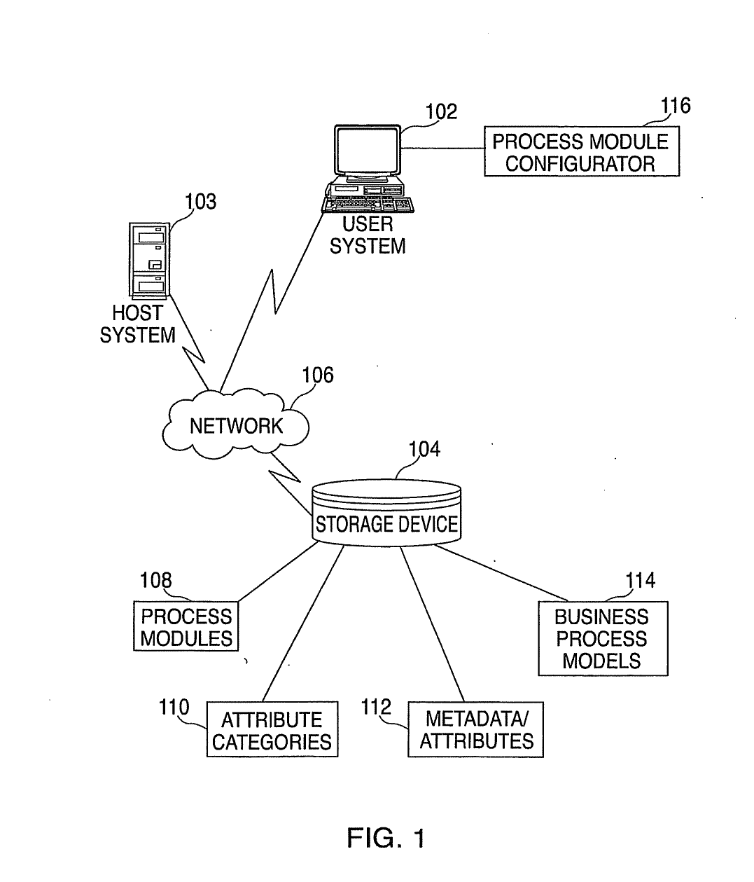

Turning now to FIG. 1, a system upon which the process module configurator may be implemented in exemplary embodiments will now be described. The system of FIG. 1 includes a host system 103, a user system 102, and a storage device 104 in communication with one another via a network 106. Host system 103 may comprise one or more servers executing within, e.g., a server/client architecture. User system 102 may be implemented using a general-purpose computer executing a computer program for carrying out the processes described herein. The user system 102 may be a personal computer (e.g., a lap top, a personal digital assistant). Network 106 may be a wireline cable, communications network (e.g., a local area network), or similar means of connection. In alternate embodiments, network 106 may be a wireless connection.

Storage device 104 may be implemented using a variety of devices for storing electronic information. It is understood that the storage device 104 may be implemented using memory contained in the host system 103 or it may be a separate physical device. Storage device 104 may be logically addressable as a consolidated data source across a distributed environment that includes network 106. Information stored in storage device 104 may be retrieved and manipulated via the host system 103, user system 102, or a combination of both.

It will be understood that host system 103 and storage device 104 may comprise a single unit whereby host system 103 contains sufficient memory to store the data and information utilized by the process module configurator system. The system of FIG. 1 illustrates these as two separate components for ease of explanation and is not to be construed as limiting in scope.

An individual on user system 102 may implement the process module configurator as described herein via an application 116 executing on the user system or on a remote system. For example, the process module configurator application 116 may be implemented via host system 103. The process module configurator application 116 may employ a standardized modeling language application for facilitating the design and workflow processes associated with a business process. For example, Business Process Execution Language (BPEL) uses a combination of web services to enable task sharing in a distributed (or grid) environment.

Storage device 104 stores process modules 108 generated by the process module configurator application 116. Process modules 108 refer to pre-designed, reusable, sub-processes, which may be assembled into larger scope business process models.

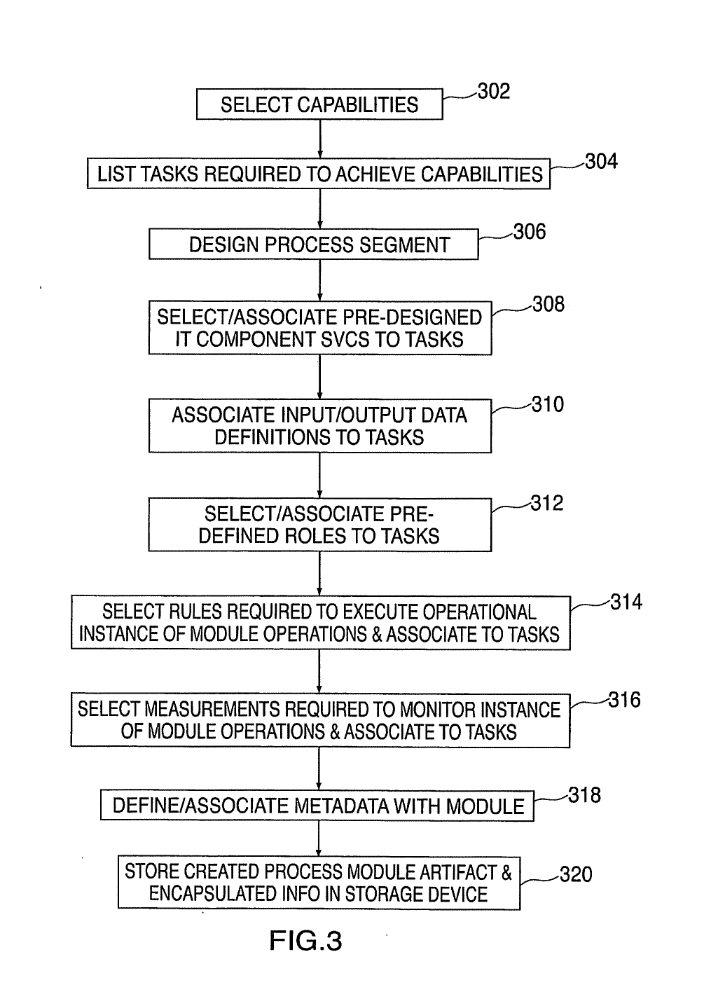

Process modules 108 consolidate and codify often-repeated business activities into reusable, ‘best practice’ designs. Process modules 108 are designed for configurable adaptability, which enable them to be applied within multiple business processes and across multiple business organizations. Design and configuration governance may be used to establish and maintain process module cross-organizational value and reusability. A user may create new process modules for activities that are not addressed by existing process modules. In addition, a user may use an existing process module as a template to create other process modules. This functionality is described further in FIG. 3.

Storage device 104 also stores configurable attribute categories 110 that include: IT component services, data, rules, roles, and metrics. Services are references to functions provided by an executable IT application. A service is generally implemented as a coarse-grained discoverable software entity, with well-defined interfaces, which interacts with applications and other services through a loosely coupled message-based communication model. Examples of services include information search services and credit validation services.

Data (or business objects), as used in this context, refer to modeling references to business records used in business processes and operational workflows. These elements may be defined by business analysts. The electronic representation of business objects must comply with a defined or proposed data model, e.g., via XML documents. Examples of business data include a purchase order, manufacturing number, and user credentials, to name a few.

Policies (or rules) are business decisions, which can be codified, and are required to guide the sequence of business tasks and govern their functions, within a business process or operational workflow. Examples of business polices or rules include (e.g., definition of “gold customer”), systems behavior (e.g., synchronous/asynchronous), operational policies (e.g., decision criteria to give a customer a discount).

Roles define references to the entities (human or system) responsible for executing specific tasks or for acquiring specific resources. Role examples include: employee, manager, administrator, user, supplier and customer.

Metrics (measurements) are algorithms that define standards of measurement about performance. Examples of metrics include: average business process execution time, service availability (uptime versus downtime), and number of invalid orders in a set of business process transactions.

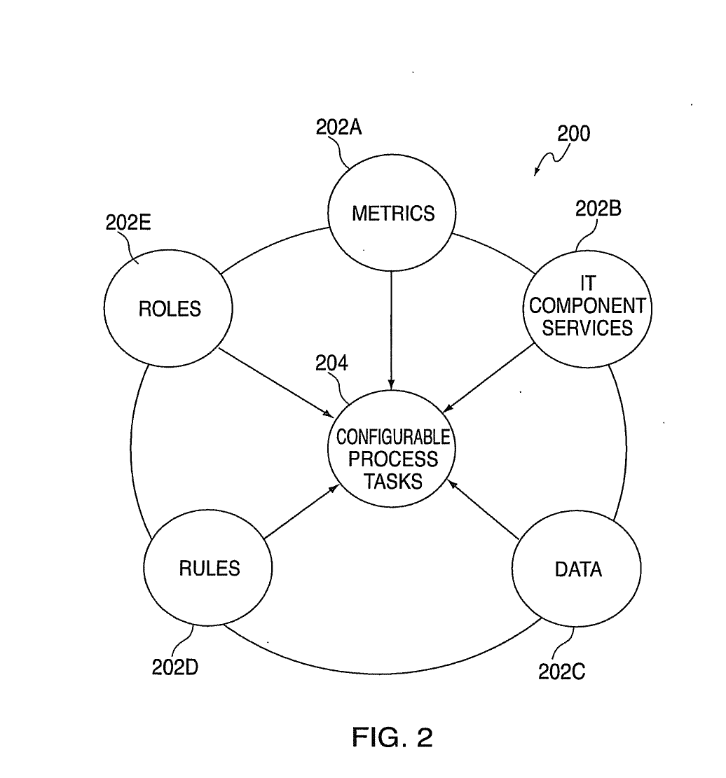

IT component services (shown generally in FIG. 2) include all general IT functions such as generic applications (e.g., applications that are accessible locally on the same server 103 as the requesting function, or remotely accessible via the network 106), database access, or any other means of invoking or accessing IT functionality to satisfy the task defined by a process module. For purposes of illustration, references to IT components described herein shall be considered an example of an IT function, with the understanding that this reference applies to all types of IT functions, along with their unique means of accessing them.

Storage device 104 also stores metadata and attributes 112 utilized by the process module configurator application 116. The metadata and attributes describe the functional capabilities provided by each process module, as well as the business and technical contexts into which the process modules have been or might be used.

Business process models 114 may also be stored in storage device 108. Business process models 114 refer to the output or final product realized as a result of generating process modules and applying the modules to a specific business problem or opportunity. Business process models 114 may be created utilizing a proprietary application or may be implemented via the business process modeling tool described in U.S. patent application Ser. No. 10/919,913 entitled, “Method, System, and Storage Medium for Performing Business Process Modeling” filed on Aug. 17, 2004, assigned to the Assignees of the instant application, and which is incorporated by reference herein in its entirety. These process models 114 may be used to generate and implement a detailed workflow for execution. Driven by business needs, a selected number of these process models can be designated (through a governance process) as reusable process segments, and therefore declared as process modules to be reused to create other larger scoped process models.

Turning now to FIG. 2, a graphical representation 200 of the process module and its configurable attributes will now be described. The circles 202A-E represent attribute categories used by the process module configurator application 116 (the details about the algorithm used by configurator will be described in FIG. 3) in creating and/or modifying business process modules. Process modules refer to reusable process segments, which may be rapidly assembled to form larger scope business process models. Process modules package and codify often-repeated business tasks into reusable, best practice designs. Process modules are also designed for easy adaptability, which enables their variations to be rapidly created and applied within selected business processes and solutions, within or across multiple business organizations and companies.

Governance of process module definition, design, and configuration changes is desired in order to establish and maintain process module, cross-organizational and multi-instance, reusability and business value. Process modules may be versioned to provide proper governance and manageability. The attributes 202A-E enable the same process module design to be easily and rapidly adapted, across an enterprise and across multiple enterprises, for reuse in new or existing solutions. These five attributes 202A-E enable a user to configure the process tasks associated with a business capability as will be described further in FIG. 3.

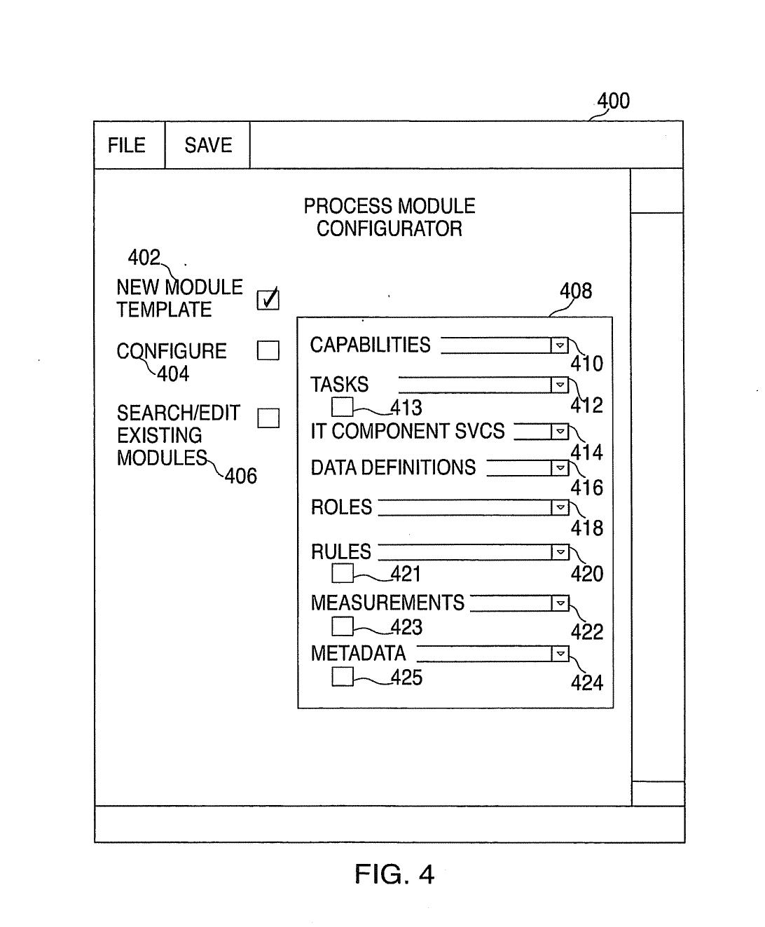

Turning now to FIG. 3, a flow diagram of a process for implementing the process module configurator application 116 in accordance with an exemplary embodiment will now be described. The process begins at step 302 whereby a user accesses the process module configurator application 116 and a user interface screen 400 such as the sample screen of FIG. 4 and main menu are presented to the user. The user interface screen 400 of FIG. 4 illustrates three menu options. New module template option 402 causes the process module configurator application 116 to provide a template for entering data relating to a new process module. By selecting the configure option 404, the user is prompted to design a process segment for the new process module initiated via option 402. Search/edit existing modules option 406 enables a user to search storage device 104 for existing business process modules 108 for viewing, modification, etc.

For purposes of illustration, an individual executing the process module configurator application 116 has performed a requirements gathering process and has determined that the scope of the business process is directed to sales solution configuration activities. The individual has also determined that a related business capability includes enabling customers to access individually entitled information and IT functionality via the Web. A business solution has been determined and provides that a ‘Login to system’ process module is to be created.

As shown in FIG. 4, the user selects option 402. The process module configurator 116 presents a subwindow 408 and prompts the user to enter information as described herein. While drop down boxes are shown in user interface screen 400, it will be understood that text boxes for data entry may be provided in lieu of, or in combination with, the drop down boxes in order to realize the advantages of the invention. The information provided by these drop down boxes may originate from any source, whether statically predefined, or dynamically created by accessing other data sources (e.g., via a search). Further, additional tools could be used to facilitate the creation of process modules including a process model tool which links tasks together and provides options to add process module attributes.

The process module configurator application 116 prompts the user to select one or more capabilities from a pre-defined list of business capabilities that may be enabled, either fully or partially, by this particular process module being constructed at step 302. These may be selected from the drop down box 410 of window 408. By way of example, the required business capability for the ‘Login to system’ process module might be described as ‘enable users to securely identify themselves to a business system using a Web browser tool and establish a secure channel to subsequently access protected functions and data based upon the user's credentials.’

The user is then prompted to list all of the tasks required to achieve each of the business capabilities selected in step 302 at step 304. This may be entered in the drop down box 412 or, if preferred, the user may select the checkbox 413, whereby the process module configurator application 116 presents a blank space in which the user may enter a specific task that is not available from the list of the drop down box 412. Each capability specified in step 302 will have one or more tasks associated therewith. Using the example provided above, the required tasks may include (a) authenticate the Web user; (b) authorize the Web user; (c) create a secure communications channel for the Web user; and (d) handle failures relating to the above tasks (a)-(c).

At step 306, the user is prompted to design a process segment by selecting a configure option 404 on screen 400. The process segment initially represents the skeleton of a process module before it is fully defined. The process segment is created by interconnecting the tasks identified in step 304 in a manner that codifies a repeatable pattern which logically transforms the required process inputs into the required outputs and outcomes, in order to achieve the business capabilities identified in step 302. The design process may be accomplished via any suitable method such as by following a blueprint on design patterns.

Utilizing the example provided above, the process module segment for the ‘Login to system’ process module is designed, interconnecting logic flow, among the tasks (a)-(d) in a manner that codifies a specific, best practice, repeatable pattern of logically transforming the required ‘Login to system’ inputs into the required outputs and outcomes that will result in the identified business capability, namely, ‘enable users to securely identify themselves to a business system using a Web browser tool and establish a secure channel to subsequently access protected functions and data based upon the user's credentials.’ The best practice logic flow codifies an ordered sequence of tasks (a)-(d) to produce a successful outcome. Each of the first three tasks has two possible outcomes: success or failure. If the execution of the task is successful, then the next task in the sequence is executed, until the sequence ends and the process is completed. If any of the three tasks (a)-(c) fails, then task (d) is executed to handle the failure, and the process is completed. It will be understood that the use of proper process modeling tool enables connecting these tasks as intended by the user. This intended use includes potential predefined relationships between specific tasks.

At step 308, the user is prompted to select and associate pre-designed IT component services to the appropriate tasks identified in the process segment configured in step 306. This step enables the selected best practices for applications or services IT enablement. The selection and association may be accomplished by selecting an IT component from a drop down box 414 as shown in FIG. 4. For purposes of illustration, it is assumed that a set of specific IT components (e.g., applications) and their associated services have previously been deployed or otherwise made available. For example, in an enterprise, the set of IT components and their associated services may implement some form (e.g., either formalized by governance or informal by availability) of an enterprise-wide IT architecture.

Utilizing the above example, the user selects and associates the predefined Web services, which are exposed from the enterprise ‘Web Identity’ IT component to the appropriate task. In this example, the Web services include (a) authenticateWS; (b) authorizeWS; and (c) createSecureChannelWS. These Web services have already been created to satisfy the need for user authentication in a company's service oriented architecture (SOA) implementation strategies. As indicated above, these selected services provide the IT application functionality and define the input/output data required to automate the tasks identified in step 304 above and the associated business decisions (e.g., is user information provided?) in order to support Web user's authentication, authorization, and communications. The aggregate of the selected services for these process tasks, with the decision logic of task (d), enable the ‘Login to system’ process module.

These Web services may be broken down further as follows:

authenticateWS: Authentication of user.
a. Get the user credentials (e.g., user ID and password) from the login conversation. If the required user credential is not provided, initiate a security challenge dialog with the user to collect the user information. After obtaining the user credential information, connect to the security directory and confirm that the user credentials are valid. Create a valid secure (e.g., encrypted) conversation channel with the identifier.
b. authorizeWS: Authorization of user.
c. Get the user credential information obtained from step (a) above. Connect to the local security directory to get the authorization information (i.e., information specifying what a user is authorized to do based upon their credentials [also known as a user's entitlements]). Map the user credential information to the respective user roles and set the user role with the context of the Web interaction.

createSecureChannelWS: Create a secure conversation channel.
d. Create the necessary security context and encrypt the channel. The tasks above are repeatable for varying security transport protocols and security mechanisms, such as SSL, Kerberos, etc.

Handle Failures
e. Notify the Web user role of the failure condition.

The user is then prompted to associate the required input and output data definitions to the appropriate process module tasks at step 310. Data definitions include associated transformation definitions that may be required for data translation between the tasks, or with the IT component services interactions. This step may be performed by selecting data definitions from a drop down box 416 as shown in FIG. 4. Utilizing the example above, the user selects and associates the user ID and password data to the ‘authenticate the Web user’ task (a). This is repeated for all data and tasks identified in step 304. Step 310 requires associated transformation definitions that may be required for data translation such as XSL scripts to transform user ID and password to a format required by the authenticating directory service IT component.

At step 312, the user is prompted to select and associate pre-defined process module execution roles to the tasks to produce the selected best practice outputs and outcomes. The selection may be performed via the drop down box 418 provided in FIG. 4. Using the example above, the user selects and associates the pre-defined role ‘Web browser’ to the ‘Authenticate Web User’ task from step 304. The user continues to select and associate pre-defined roles (e.g., Web browser, Web customer, and Business partner) to each of the remaining tasks to enable the execution of the ‘Login to system’ process module.

The user then defines (via checkbox 421) or selects from a predefined list (via drop down box 420), the operational business rules required to properly execute the operational instance of the process module and associate them to the appropriate tasks to govern the process module execution at step 314. Using the above example, the user defines and associates the following operational business rules to the ‘Authenticate Web user’ task:
user can be allowed as a generic guest with predefined, but limited authorizations (e.g., userid=guest)
allowable number of login attempts
access to order submissions requires non-repudiation which can be verified through the use of digital certificates

The user then defines (via checkbox 423), or selects from a predefined list (via drop down box 422), the business process metrics (i.e., measurement standards) required to monitor a particular instance of process module operations, and associate them to the appropriate tasks in the module to specify the generation of the corresponding monitoring data during execution at step 316. An example of an operational metric may be ‘elapsed time from user first login attempt to successful secure communications channel enabled’ that is associated with the ‘Authenticate Web user’ and the ‘Create Secure Communications Channel’ tasks identified in step 304.

At step 318, the user defines (via check box 425 or drop down box 424) and associates metadata with the process module. Metadata includes business purpose, functional capabilities, key search words, etc., that can later assist subsequent users to efficiently and effectively search and select the appropriate process module for reuse. Using the above example, metadata defined may include the following:
purpose=enable individualized access to Web system data and functions
capabilities=Web user authentication, authorization, and secure communications
key search words=login, Web, Access, Authenticate, Authorize
where used=supply chain, life sciences, .com
process module owner=first/last name, organization
applicable run-time environments=IBM® WebSphere

At step 320, the process module created as a result of executing steps 302-318, along with its encapsulated information, is stored in storage device 104. These process modules may then be retrieved and used in creating business models.

As described above with respect to FIG. 1, the business process module activities of the present invention may reside on a stand-alone computer system, which may have access to the Internet, or may reside on a computer system which is part of the network through which there is Internet access. With a connection to a network and/or the Internet, there are several different ways in which the process software used to implement the systems and methods of the process module configurator system may be integrated with the network, and deployed using a local network, a remote network, an e-mail system, and/or a virtual private network. The following descriptions review the various ways of accomplishing these activities.

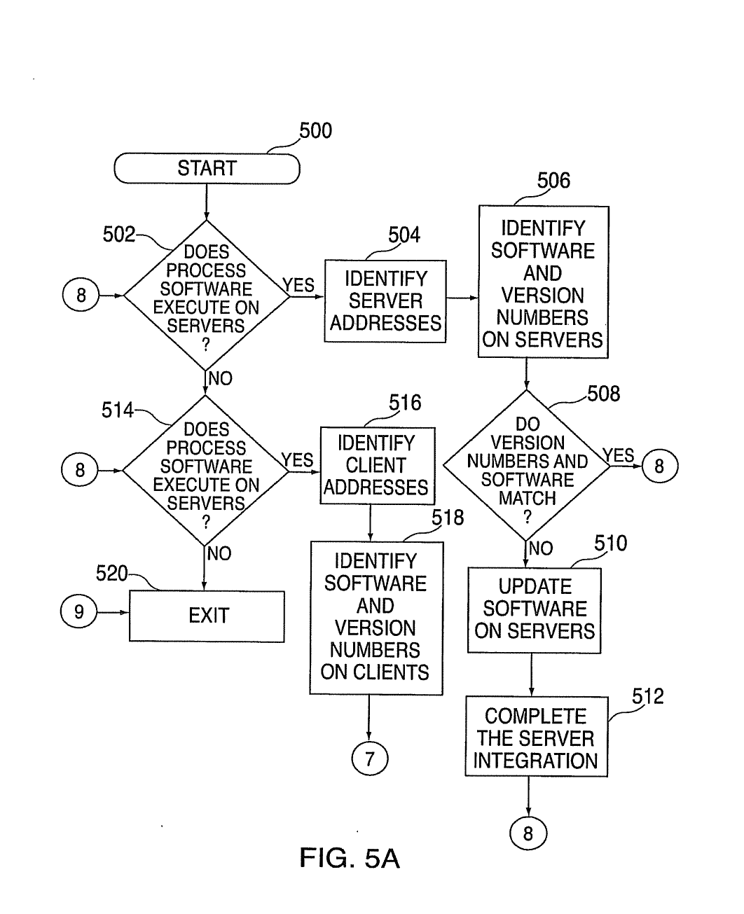

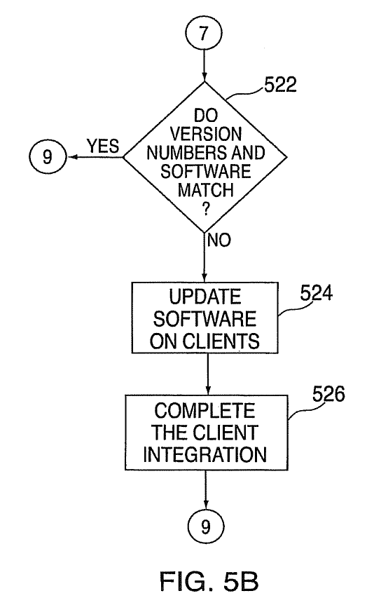

Integration of Process Module Configurator System Software. To implement the business process module systems and methods of the present invention, process software, which is composed of the software as described above and related components including any needed data structures, is written and then if desired, integrated into a client, server, and network environment. This integration is accomplished by taking those steps needed to enable the process software to coexist with other application, operating system and network operating system software and then installing the process software on the clients and servers in the environment where the process software will function. An overview of this integration activity will now be provided, followed by a more detailed description of the same with reference to the flowcharts of FIGS. 5A and 5B.

The first step in the integration activity is to identify any software on the clients and servers where the process software will be deployed that are required by the process software or that need to work in conjunction with the process software. This includes the network operating system, which is the software that enhances a basic operating system by adding networking features.

Next, the software applications and version numbers are identified and compared to the list of software applications and version numbers that have been tested to work with the process software. Those software applications that are missing or that do not match the correct version are upgraded with the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems including the network operating systems are identified and compared to the list of operating systems, version numbers, and network software that have been tested to work with the process software. Those operating systems, version numbers, and network software that do not match the list of tested operating systems and version numbers are then upgraded on the clients and servers to the required level.

After ensuring that the software resident on the computer systems where the process software is to be deployed is at the correct version level(s), that is, has been tested to work with the process software, the integration is completed. This is done by installing the process software on the clients and servers. Armed with the foregoing overview of the integration activity, the following detailed description of the same should be readily understood.

Referring to FIGS. 5A and 5B, step 500 begins the integration of the process software for implementing the process module configurator systems and methods of the present invention. It is determined whether there are any process software programs that will execute on a server or servers at step 502. If this is not the case, then integration proceeds to determine if the process software will execute on clients at step 514. If there are process software programs that will execute on a server(s), then the server addresses are identified at step 504. The servers are checked to see if they contain software that includes the operating system (OS), applications, and network operating systems (NOS), together with their version numbers, that have been tested with the process software at step 506. The servers are also checked to determine if there is any missing software that is required by the process software as part of the activity at step 506. A determination is made whether the version numbers match the version numbers of OS, applications and NOS that have been tested with the process software at step 508. If all of the versions match, and there is no missing required software, the integration continues at step 514. If one or more of the version numbers do not match, then the unmatched versions are updated on the server or servers with the correct versions at step 510. Additionally, if there is missing required software, then it is updated on the server or servers at step 510. The server integration is completed by installing the process software at step 512.

Step 514, which follows either step 502, 508 or 512, determines if there are any programs of the process software that will execute on the clients. If no process software programs execute on the clients, the integration proceeds to step 520 and exits. If there are process software programs that will execute on clients, the client addresses are identified at step 516.

At step 518, the clients are checked to see if they contain software that includes the operating system (OS), applications, and network operating systems (NOS) software, together with their version numbers, that have been tested with the process software. The clients are also checked at step 518 to determine if there is any missing software that is required by the process software.

At step 522, a determination is made if the version numbers match the version numbers of OS, applications and NOS that have been tested with the process software. If all of the versions match, and there is no missing required software, then the integration proceeds to step 520 and exits.

If one or more of the version numbers do not match, then the unmatched versions are updated on the clients with the correct versions at step 524. In addition, if there is missing required software, then it is updated on the clients as part of step 524. The client integration is completed by installing the process software on the clients at step 526. The integration proceeds to step 520 and exits.

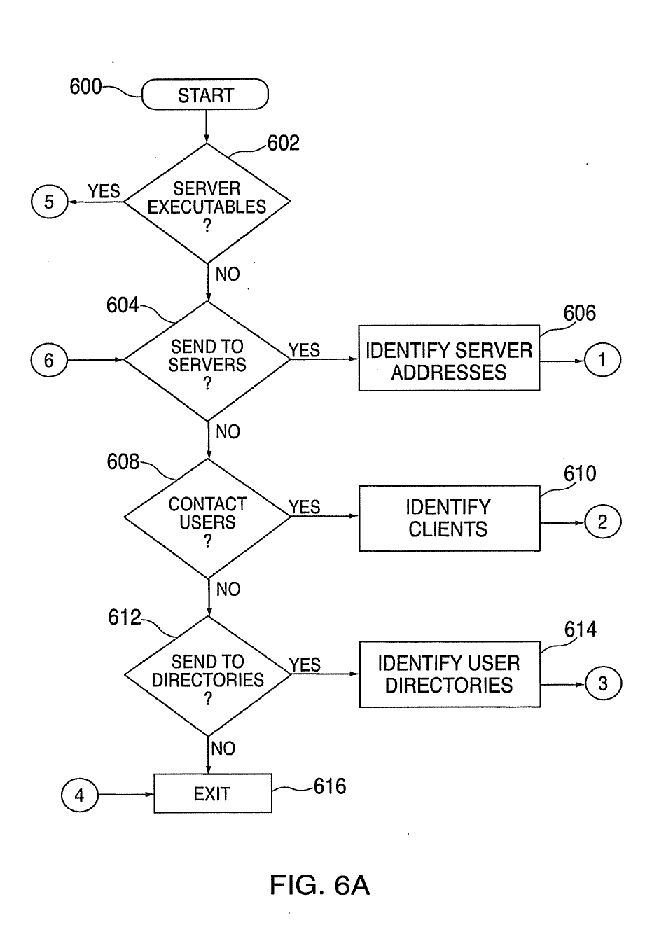

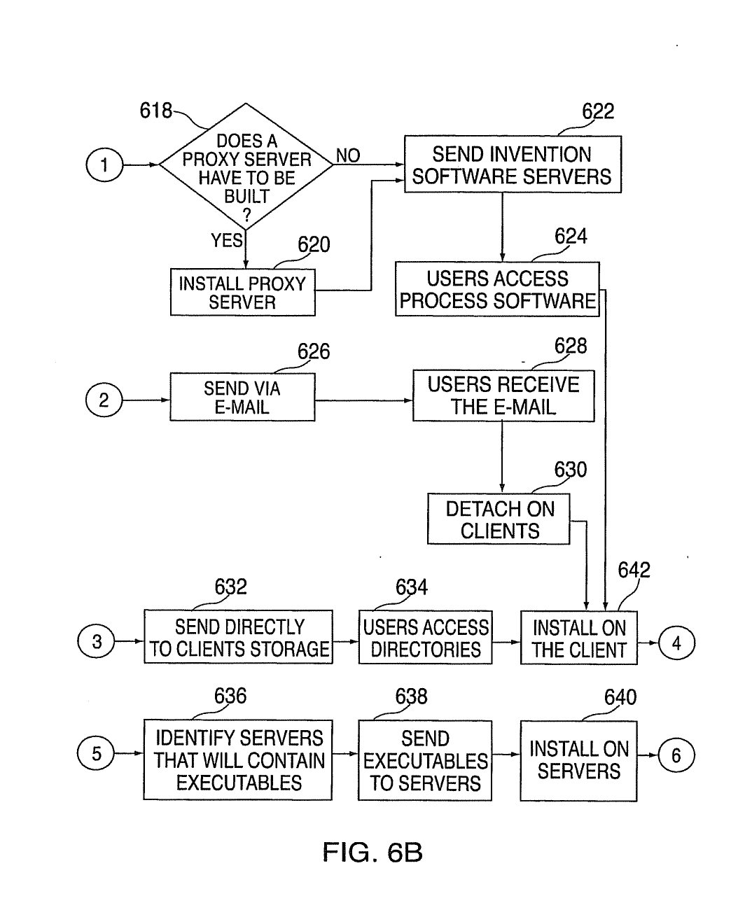

Deployment of Process Module Configurator System Software. It should be well understood that the process software for implementing the process module configurator of the present invention may be deployed by manually loading the process software directly into the client, server, and proxy computers from a suitable storage medium such as a CD, DVD, etc. It is useful to provide an overview of still other ways in which the process software may also be automatically or semi-automatically deployed into one or more computer systems. The process software may be deployed by sending or loading the process software to a central server or a group of central servers. From there, the process software may then be downloaded into the client computers that will execute the process software. Alternatively, the process software may be sent directly to the client system via e-mail. The process software is then either detached to a directory or loaded into a directory by a button on the e-mail that executes a program that detaches the process software attached to the e-mail into a directory. Another alternative is to send the process software directly to a directory on the hard drive of a client computer. Also, when there are proxy servers, the automatic or self-automatic deployment process will select the proxy server code, determine on which computers to place the proxy servers' code, transmit the proxy server code, and then install the proxy server code on the proxy computer. The process software will be transmitted to the proxy server and then stored on the proxy server. Armed with this overview of the possible deployment processes, the following detailed description of the same with reference to FIGS. 6A and 6B, where the deployment processes are illustrated, will be more easily understood.

Step 600 begins the deployment of the process software. It is determined whether there are any programs that will reside on a server or servers when the process software is executed at step 602. If the answer is “yes”, then the servers that will contain the executables are identified, as indicated in step 636 in FIG. 6B. The process software for the server or servers is transferred directly to the servers' storage via FTP or some other protocol or by copying though the use of a shared file system at step 638. The process software is then installed on the servers as indicated at step 640.

Next, as shown in step 604 in FIG. 6A, a determination is made on whether the process software is to be deployed by having users access the process software on a server or servers. If the users are to access the process software on servers, then the server addresses that will store the process software are identified at step 606.

Next, as shown at step 618, a determination is made if a proxy server is to be built to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed as indicated at step 620. Next, the process software for implementing the present invention is sent to the servers, as indicated in step 622 either via a protocol such as FTP or it is copied directly from the source files to the server files via file sharing. Another way of sending the process software to the servers is to send a transaction to the servers that contained the process software and have the server process the transaction. In this manner, the process software may be received by and copied into the server's file system. Once the process software is stored at the servers, the users via their client computers, then access the process software on the servers and copy it into to the file systems of their client computers at step 624. Another alternative is to have the servers automatically copy the process software to each client and then run the installation program for the process software at each client computer. Either way, the user computer executes or causes to be executed the program that installs the process software on the client computer at step 642, then the process exits at step 616.

Continuing now at step 608 in FIG. 6A, a determination is made as to whether the process software is to be deployed by sending the process software to users via e-mail. If the answer is yes, then, as indicated at step 610, the set of users where the process software will be deployed are identified together with the addresses of the user client computers. The process software is sent via e-mail in step 626 (shown in FIG. 6B) to each of the users' client computers. Then, as indicated in step 628, the users receive the e-mail, and then detach the process software from the e-mail to a directory on their client computers at step 630. The user then executes the program that installs the process software on his client computer at step 642, and then exits the process at step 616.

Continuing at step 612 (see bottom of FIG. 6A), a determination is made on whether the process software will be sent directly to user directories on their client computers. If so, the user directories are identified at step 614. Then, the process software is transferred directly to the identified directory on the user's client computer, as indicated in step 632. This can be done in several ways such as, but not limited to, sharing of the file system directories and then copying them from the sender's file system to the recipient user's file system or, alternatively, using a transfer protocol such as File Transfer Protocol (FTP). Next, the users access the directories on their client file systems, as indicated in step 634, in preparation for installing the process software. Finally, the user executes the program that installs the process software on his client computer at step 642 and then exits the process at step 616.

Use of Virtual Private Networks for Process Module Configurator System Software. The process software may be deployed, accessed and executed through the use of a virtual private network (VPN). A VPN is any combination of technologies that can be used to secure a connection through an otherwise unsecured or untrusted network. VPNs are used to improve security and can often also reduce operational costs. The VPN makes use of a public network, usually the Internet, to connect remote sites or users together. Instead of using a dedicated, real-world connection such as a leased line, the VPN uses “virtual” connections routed through the Internet from the company's private network to the remote site or employee(s). Access to the software via a VPN can be provided as a service by specifically constructing the VPN for purposes of delivery or execution of the process software (i.e., the software resides elsewhere). In such an instance, the lifetime of the VPN is often limited to a given period of time or to a given number of deployments based on an amount paid.

The process software may be deployed, accessed, and executed through either a remote-access VPN or a site-to-site VPN. When using a remote-access VPN, the process software is typically deployed, accessed, and executed via the secure, encrypted connections between a company's private network and remote users through a third-party service provider. The enterprise service provider (ESP) sets up and/or authorizes access to a network access server (NAS) and provides the remote users with desktop client software for their computers. The telecommuters can then dial a phone number (often a toll-free number) or attach directly via a cable, DSL, or wireless modem to reach the NAS and use their VPN client software to access the corporate network and to access, download, and execute the process software.

When using a site-to-site VPN, the process software is typically deployed, accessed and executed through the use of dedicated equipment and large-scale encryption. These tools are often used to connect multiple fixed sites of a larger company over a public network such as the Internet.

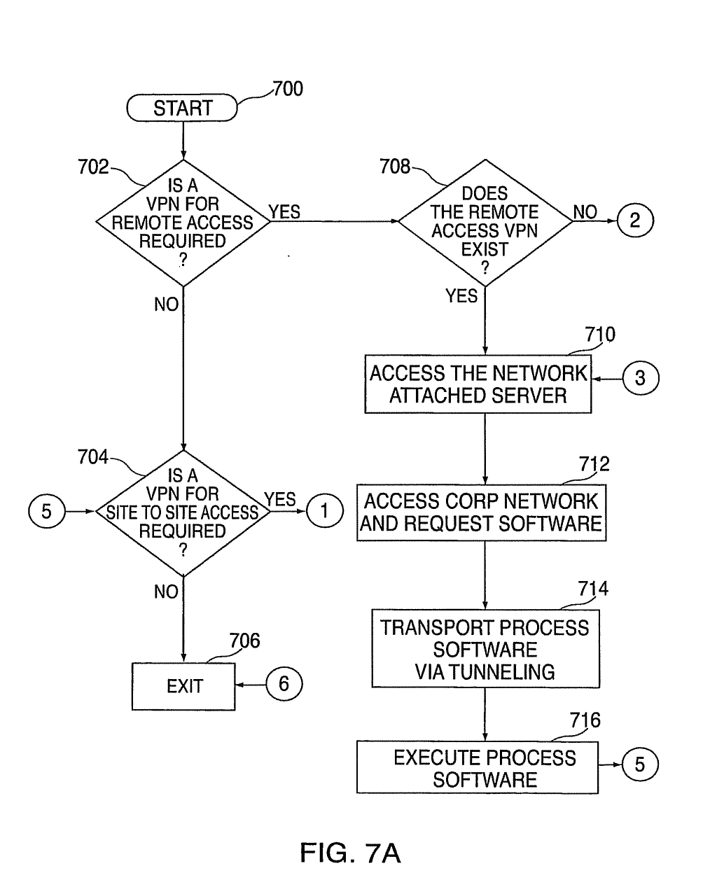

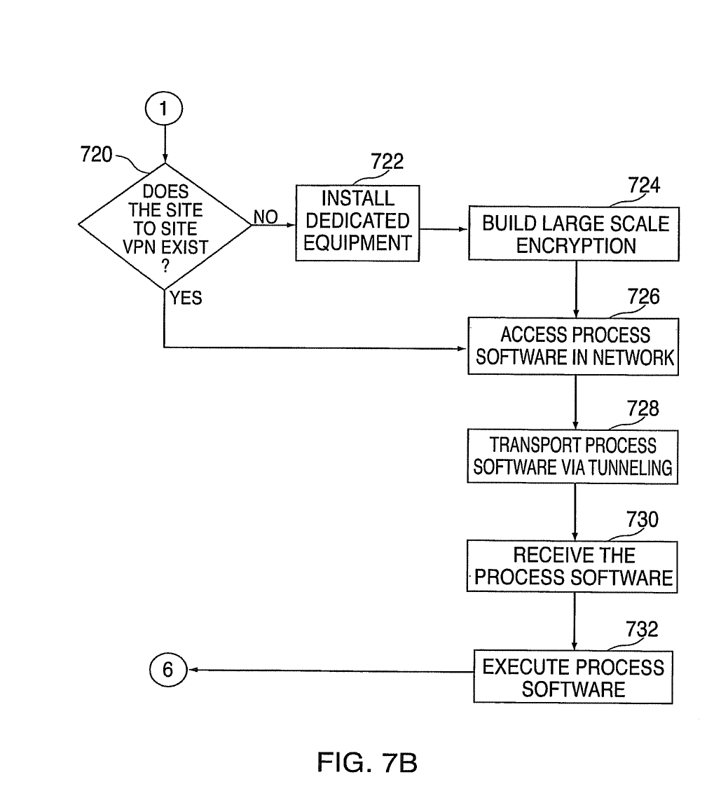

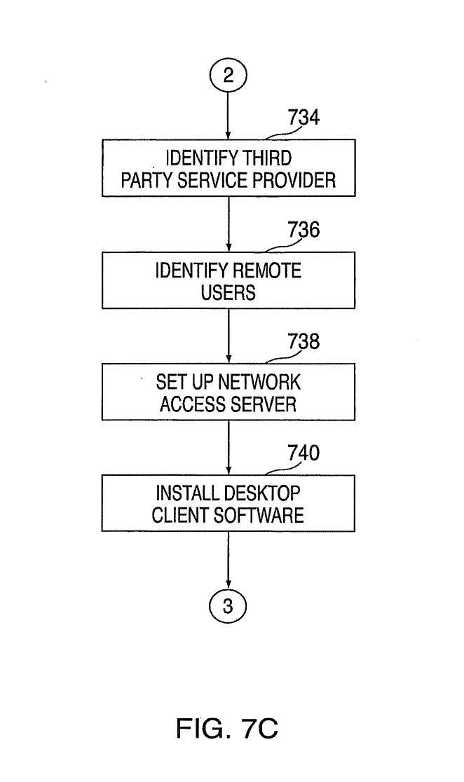

The process software is transported over the VPN via a process called tunneling. Tunneling is process involving the placing of an entire packet within another packet and sending it over a network. The protocol of the outer packet is understood by the network and by both points, called tunnel interfaces, where the packet enters and exits the network. Tunneling generally encapsulates the private network data and protocol information within the public network transmissions so that the private network protocol information appears to the public network simply as unintelligible data. Armed with the foregoing overview of virtual private networks and how they operate and how they may be used to transport the process software, the following more detailed description of same with reference to the flowcharts of FIGS. 7A-7C should be more readily understood.

Step 700 in FIG. 7A begins the virtual private network (VPN) process. A determination is made at step 702 to see if a VPN for remote access is required. If it is not required, then flow proceeds to step 704. If it is required, then flow proceeds to step 708 where a determination is made as to whether a remote access VPN exists that is available for use.

If a remote access VPN does exist, then flow proceeds to step 710 in FIG. 7A. Otherwise flow proceeds to step 734 (see top of FIG. 7C), where a third party provider that will provide the secure, encrypted connections between the company's private network and the company's remote users is identified. Next, as indicated in step 736, the company's remote users are identified. Then, at step 738, the identified third party provider then sets up a network access server (NAS). The NAS allows the remote users to dial a phone number (typically a toll free number) or attach directly via a cable, DSL, wireless or other modem to access, download and install the desktop client software for the remote-access VPN as indicated at step 740.

Returning to step 710 in FIG. 7A, after the remote access VPN has been built or if it been previously installed, the remote users can then access the process software by dialing into the NAS or attaching directly via a cable, DSL, or other modem into the NAS. This step 710 allows entry into the corporate network, as indicated at step 712, where the process software may be accessed. The process software is transported to the remote user's desktop computer over the network via tunneling. During tunneling, see step 714, the process software is divided into packets and each packet, including the data and protocol for that packet, is placed within another packet. When the process software arrives at the remote user's desktop computer, it is removed from the packets, reconstituted, and then may be executed on the remote users desktop, as indicated at step 716.

Returning now to step 704 in FIG. 7A, a determination is made to see if a VPN for site-to-site access is required. If it is not required, then the process exits at step 706. If it is required, flow proceeds to step 720 (see top of FIG. 7B) to determine if the site-to-site VPN exists. If it does exist, then flow proceeds to step 726. If it does not exist, then as indicated at step 722, dedicated equipment required to establish a site-to-site VPN is installed. Then the large-scale encryption is built into the VPN at step 724.

After the site-to-site VPN has been built or if it had been previously established, the users access the process software via the VPN as indicated in step 726. Next, the process software is transported to the site users over the network via tunneling as indicated in step 728. As previously explained, the process software is divided into packets and each packet including the data and protocol is placed within another packet, as indicated in step 730. When the process software arrives at the remote user's desktop, it is removed from the packets, reconstituted, and is executed on the site users desktop at step 732. The process then proceeds to step 706 and exits.

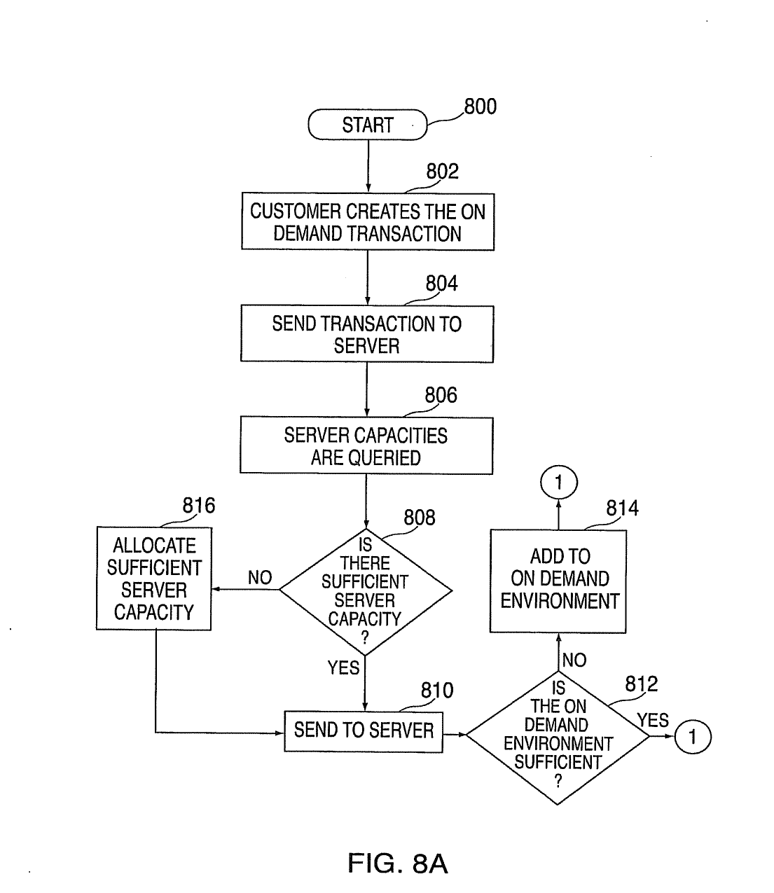

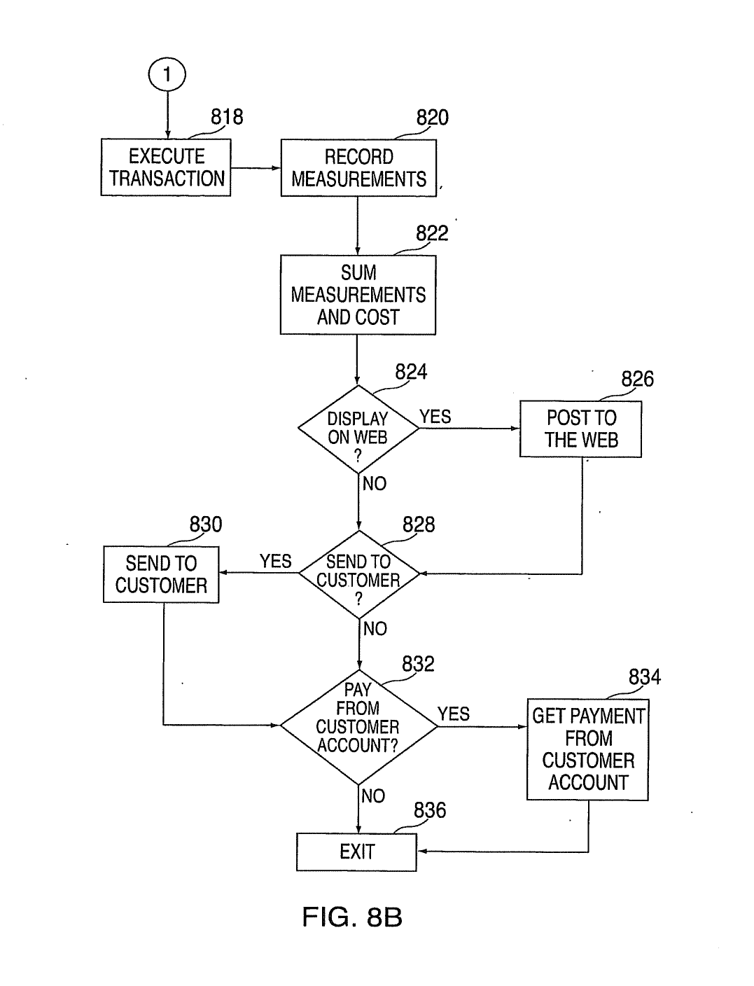

On Demand Computing for Process Module Configurator System Software. The process software for implementing the process module configurator system of the present invention may be shared; that is, it may be used to simultaneously serve multiple customers in a flexible, automated fashion. It is process software that is easily standardized, requiring little customization, and it is scalable, thus providing capacity on demand in a pay-as-you-go model known as “on demand” computing. An overview of on demand computing as applied to the process module configurator system software will now be provided, followed by a more detailed description of same made with reference to the flowcharts of FIGS. 8A and 8B.

The process software for implementing the present invention can be stored on a shared file system accessible from one or more servers. The process software may be executed via transactions that contain data and server processing requests that use measurable CPU units on the accessed server. CPU units are units of time such as minutes, seconds, and hours on the central processor of the server. Additionally, the accessed server may make requests of other servers that require CPU units. CPU units are an example that represents but one measurement of use. Other measurements of use include, but are not limited to, network bandwidth, memory usage, storage usage, packet transfers, complete transactions, etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise, when other measurements of use such as network bandwidth, memory usage, storage usage, etc., approach a capacity so as to affect performance, additional network bandwidth, memory usage, storage etc. are added as needed to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer who then remits payment to the service provider.

In another embodiment, the service provider requests payment directly from a customer account at a banking or financial institution. In yet another embodiment, if the service provider is also a customer of the customer that uses the process software application, the payment owed to the service provider is reconciled to the payment owed by the service provider to minimize the transfer of payments. Armed with the foregoing overview, the detailed description of the on demand computing with respect to the process software, and the following detailed description of same with reference to FIGS. 8A and 8B where the on demand processes are illustrated, will be more easily understood.

Step 800 begins the On Demand process. A transaction is created that contains the unique customer identification, the requested service type and any service parameters that further specify the type of service as indicated in step 802. The transaction is then sent to the main server as shown in step 804. In an On Demand environment, the main server may initially be the only server. Then, as capacity is consumed, other servers are added to the On Demand environment.

The server central processing unit (CPU) capacities in the On Demand environment are queried at step 806. The CPU requirement of the transaction is estimated, then the servers' available CPU capacity in the On Demand environment are compared to the transaction CPU requirement to see if there is sufficient CPU available capacity in any server to process the transaction as indicated in step 808. If there is not sufficient server CPU available capacity, then additional server CPU capacity is allocated to process the transaction as indicated in step 816. If there was already sufficient available CPU capacity, the transaction is sent to a selected server at step 810.

Before executing the transaction, a check is made of the remaining On Demand environment to determine if the environment has sufficient available capacity for processing the transaction as indicated at step 812. This environment capacity consists of elements such as, but not limited to, network bandwidth, processor memory, storage, etc. If there is insufficient available capacity, then capacity will be added to the On Demand environment as indicated in step 814. Next the required software to process the transaction is accessed, loaded into memory, and the transaction is executed as indicated in step 818.

The usage measurements are recorded as indicated in step 820. The usage measurements consist of the portions of those functions in the On Demand environment that are used to process the transaction. The usage of functions such as, but not limited to, network bandwidth, processor memory, storage and CPU cycles are what is recorded. The usage measurements are summed, multiplied by unit costs, and then recorded as a charge to the requesting customer as indicated in step 822.

If the customer has requested that the On Demand costs be posted to a web site as indicated in step 824, then they are posted to a web site at step 826. If the customer has requested that the On Demand costs be sent via e-mail to a customer address as indicated in step 828, then they are sent to the customer via e-mail as indicated in step 830. If the customer has requested that the On Demand costs be paid directly from a customer account at step 832, then payment is received directly from the customer account at step 834. The On Demand process proceeds to step 836 and then exits.

As indicated above, the process module configurator enables businesses to encapsulate business functions, as assets, by codifying best practice process segment designs into rapidly reusable and selectively adaptable process modules. The use of process modules can reduce business solution time-to-value, and related cost/expense, especially in the design, development, testing, and deployment phases of solution projects. In addition, process modules that are instantiated as workflow segments enable those workflow segments to be more quickly and easily adaptable to changing, on demand, market requirements than the more traditional monolithic solution designs. Process modules have associated metadata (e.g., process module business purpose, functional capabilities, key search words, cost metrics, etc.), to assist users in efficiently and effectively searching, selecting, and using process modules.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for implementing business process modules for performing business process modeling, comprising:
identifying tasks required in order to achieve a capability;
designing a process module for enabling the capability, the designing including interconnecting logic flow among the tasks, the interconnecting logic flow resulting in an optimized, repeatable pattern of logically transformed inputs to outputs required for achieving the capability;
selecting and associating attributes to the tasks, the attributes selected from categories including:
information technology component services;
data;
operational business rules;
roles; and
measurements; and
defining and associating metadata with the process module, the metadata operable for describing functional capabilities provided by the process module and business and technical contexts into which the process module is used.

2. The method of claim 1, wherein the information technology component services include at least one of:
generic applications;
database access; and
a means for invoking or accessing information technology functionality for satisfying a task defined by the process module.

3. The method of claim 1, wherein the data attributes input and output data definitions include at least one of: associated transformation definitions required for data translation between the tasks, and information technology component services interactions.

4. The method of claim 1, wherein the operational business rules attributes include rules required for executing an operational instance of the process module and associate the rules with appropriate tasks.

5. The method of claim 1, wherein the roles attributes include execution roles required for producing optimized outputs and outcomes.

6. The method of claim 1, wherein the at least one process module includes pre-designed, reusable sub-processes.

7. The method of claim 1, wherein the measurements attributes include metrics required for monitoring an instance of a process module's operations.

8. The method of claim 1, wherein the metadata further includes key words associated with the process module, the key words operable for facilitating search, selection, and governance of the process model for subsequent reuse.

9. The method of claim 1, further comprising deploying process software for implementing business process modules for performing business process modeling, said deploying comprising:
installing said process software on at least one server;
identifying server addresses for users accessing said process software on said at least one server;
installing a proxy server if needed;
sending said process software to said at least one server and copying said process software to a file system of said at least one server;
sending the process software to at least a first client computer; and
executing said process software on said first client computer.

10. The method of claim 1, further comprising integrating process software for implementing business process modules for performing business process modeling, said integrating comprising:
determining if said process software will execute on at least one server;
identifying an address of said at least one server;
checking said at least one server for operating systems, applications, and version numbers for validation with said process software, and identifying any missing software applications for said at least one server that are required for integration;
updating said at least one server with respect to any operating system and application that is not validated for said process software, and providing any of said missing software applications for said at least one server required for said integration;
identifying client addresses and checking client computers for operating systems, applications, and version numbers for validation with said process software, and identifying any software applications missing from said client computers that are required for integration;
updating said client computers with respect to any operating system and application that is not validated for said process software, and providing any missing software application for said client computers required for said integration; and
installing said process software on said client computers and said at least one server.

11. The method of claim 1, farther comprising on-demand sharing of process software for implementing business process modules for performing business process modeling, said on demand sharing comprising:
creating a transaction containing unique customer identification, requested service type, and service parameters;
sending said transaction to at least one main server;
querying said at least one main server about processing capacity associated with said at least one main server to help ensure availability of adequate resources for processing of said transaction; and
allocating additional processing capacity when additional capacity appears needed to process said transaction, said additional processing capacity being selected from the group of additional capacities consisting of central processing unit capacity, processor memory capacity, network bandwidth capacity, and storage capacity.

12. The method of claim 1, further comprising deploying, accessing, and executing process software for implementing business process modules for performing business process modeling, said deploying, accessing, and executing process software implemented through a virtual private network, the method further comprising:
determining if a virtual private network is required;
checking for remote access to said virtual private network when it is required;
if said remote access does not exist, identifying a third party provider to provide secure, encrypted connections between a private network and remote users;
identifying said remote users; and
setting up a network access server operable for downloading and installing client software on desktop computers for remote access of said virtual private network;
accessing said process software;
transporting said process software to at least one remote user's desktop computer; and
executing said process software on said at least one remote user's desktop computer.

13. A storage medium encoded with machine-readable program code for performing business process modeling, the program code including instructions for causing a processor to implement a method, comprising:
identifying tasks required in order to achieve a capability;
designing a process module for enabling the capability, the designing including interconnecting logic flow among the tasks, the interconnecting logic flow resulting in an optimized, repeatable pattern of logically transformed inputs to outputs required for achieving the capability;
selecting and associating attributes to the tasks, the attributes selected from categories including:
information technology component services;
data;
operational business rules;
roles; and
measurements; and
defining and associating metadata with the process module, the metadata operable for describing functional capabilities provided by the process module and business and technical contexts into which the process module is used.

14. The storage medium of claim 13, wherein the information technology component services include at least one of:
generic applications;
database access; and
a means for invoking or accessing information technology functionality for satisfying a task defined by the process module.

15. The storage medium of claim 13, wherein the data attributes input and output data definitions include at least one of associated transformation definitions required for data translation between the tasks, and information technology component services interactions.

16. The storage medium of claim 13, wherein the operational business rules attributes include rules required for executing an operational instance of the process module and associating the rules with appropriate tasks.

17. The storage medium of claim 13, wherein the roles attributes include execution roles required for producing optimized outputs and outcomes.

18. The storage medium of claim 13, wherein the metadata further includes key words associated with the process module, the key words operable for facilitating search, selection, and governance of the process model for subsequent reuse.

19. A system for performing business process modeling, comprising:
a user system including a processor, the user system in communication with a storage device;
a process module configurator application executing on the user system, the process model configurator application performing:
identifying tasks required in order to achieve a capability;
designing a process module for enabling the capability, the designing including interconnecting logic flow among the tasks, the interconnecting logic flow resulting in an optimized, repeatable pattern of logically transformed inputs to outputs required for achieving the capability;
selecting and associating attributes to the tasks, the attributes selected from categories including:
information technology component services;
data;
operational business rules;
roles; and
measurements; and
defining and associating metadata with the process module, the metadata operable for describing functional capabilities provided by the process module and business and technical contexts into which the process module is used.

20. The system of claim 19, wherein the information technology component services include at least one of:
generic applications;
database access; and
a means for invoking or accessing information technology functionality for satisfying a task defined by the process module.

21. The system of claim 19, wherein the data attributes input and output data definitions including at least one of associated transformation definitions required for data translation between the tasks, and information technology component services interactions.

22. The system of claim 19, wherein the operational business rules attributes include rules required for executing an operational instance of the process module and associating the rules to appropriate tasks.

23. The system of claim 19, wherein the roles attributes include execution roles required for producing optimized outputs and outcomes.

24. The system of claim 19, wherein the measurements attributes include metrics required for monitoring an instance of a process module's operations.
